(19) United States
(12) Patent Application Publication
(10) Pub. No.: US 2002/0145945 A1
(43) Pub. Date: Oct. 10, 2002

(54) Clock or watch

(76) Inventor: Gabrielle Bucci, Gualdicciolo (SM)

Correspondence Address: BROWDY AND NEIMARK, P.L.L.C., 624 NINTH STREET, NW, SUITE 300, WASHINGTON, DC, 20001-5303, US

(21) Appl. No.: 09/726,551

(22) Filed: Dec. 1, 2000

(30) Foreign Application Priority Data
Dec. 3, 1999 (SM) SM-A-199900001

(51) Int. Cl. G04C 17/00; G04B 19/00

(52) U.S. Cl. 368/223

(57) ABSTRACT

The invention relates to a clock or watch. It comprises a casing (1), at least one cursor (2) and an indicator (3) which are joined together and at least one first graduated scale (4) extending in a linear manner. The clock or watch (10) preferably also comprises at least one second graduated scale (5) for separate scanning of the hours and the minutes. The indicator (3) joined to the cursor may have various constructional forms, from among which a pointer, a lens and a luminous signal have been illustrated by way of example.

### BACKGROUND OF THE INVENTION

1. Field of the invention

The present invention relates to a clock or watch.

2. Description of the prior art

The use of instruments for measuring the time is a practise which dates back to ancient times. Probably the relative rotational movement of the sun and the earth has had a decisive influence on the inventors of these instruments so much so that they have also adopted to a certain extent a similar rotational movement of this type: for example, modern wrist watches, large clocks situated in town squares or the more ancient sundials. In all these examples the particular movable part indicating hours and minutes performs a rotational movement, whether it consists of the hands or the shadow cast by the sun.

Only the more recent liquid crystal watches use a system for displaying the passing of time based on a succession of digits which are directly visible to the person viewing this information.

Clocks or watches with a substantially circular shape or in any case those in which the hands follow curved paths require a high degree of precision both in order to synchronize the movement of the hands with the passing of time and because of the interference between them.

### SUMMARY OF THE INVENTION

The object of the present invention is therefore to eliminate the drawbacks mentioned above.

The invention, which is characterized by the claims, solves the problems of providing direct and rapid reading of the time in clocks or watches operating with hands—or in any case with indicators—and a dial.

The main advantage obtained by means of the present invention consists essentially in the fact that the time indicated may be determined with the maximum precision. Moreover, it is possible to avoid the use of complicated rotary mechanisms inside the casing of the clock or watch, replacing them with mechanisms which have a linear movement.

### BRIEF DESCRIPTION OF THE DRAWINGS

Further advantages and characteristic features of the invention will emerge more clearly from the following detailed description, with reference to the accompanying drawings which show a non-limiting example of embodiment thereof and in which:

FIG. 1 shows a front view of an embodiment thereof, with some parts removed so that others may be seen more clearly and with an enlarged detail;

FIGS. 2, 3 and 4 show alternative embodiments of the invention.

### DETAILED DESCRIPTION OF THE PREFERRED EMBODIMENT(S)

The present invention relates to a clock or watch. It comprises a casing (1), at least one cursor (2) and an indicator (3) which are joined together and at least one first graduated scale (4) extending in a linear manner. In the case where the invention must be used as a wrist watch, in order to ensure that the dimensions of the watch (10) remain sufficiently small, the first graduated scale is divided into several sections (4a, 4b, etc.) as can be seen in some of the illustrations of examples accompanying the present invention.

It is obvious that, within the scope of the invention, the constructional solution which envisages a graduated scale (4) contained within one section is nevertheless included: this solution will obviously be preferable in larger size clocks (10) which could be, for example, table clocks or wall clocks.

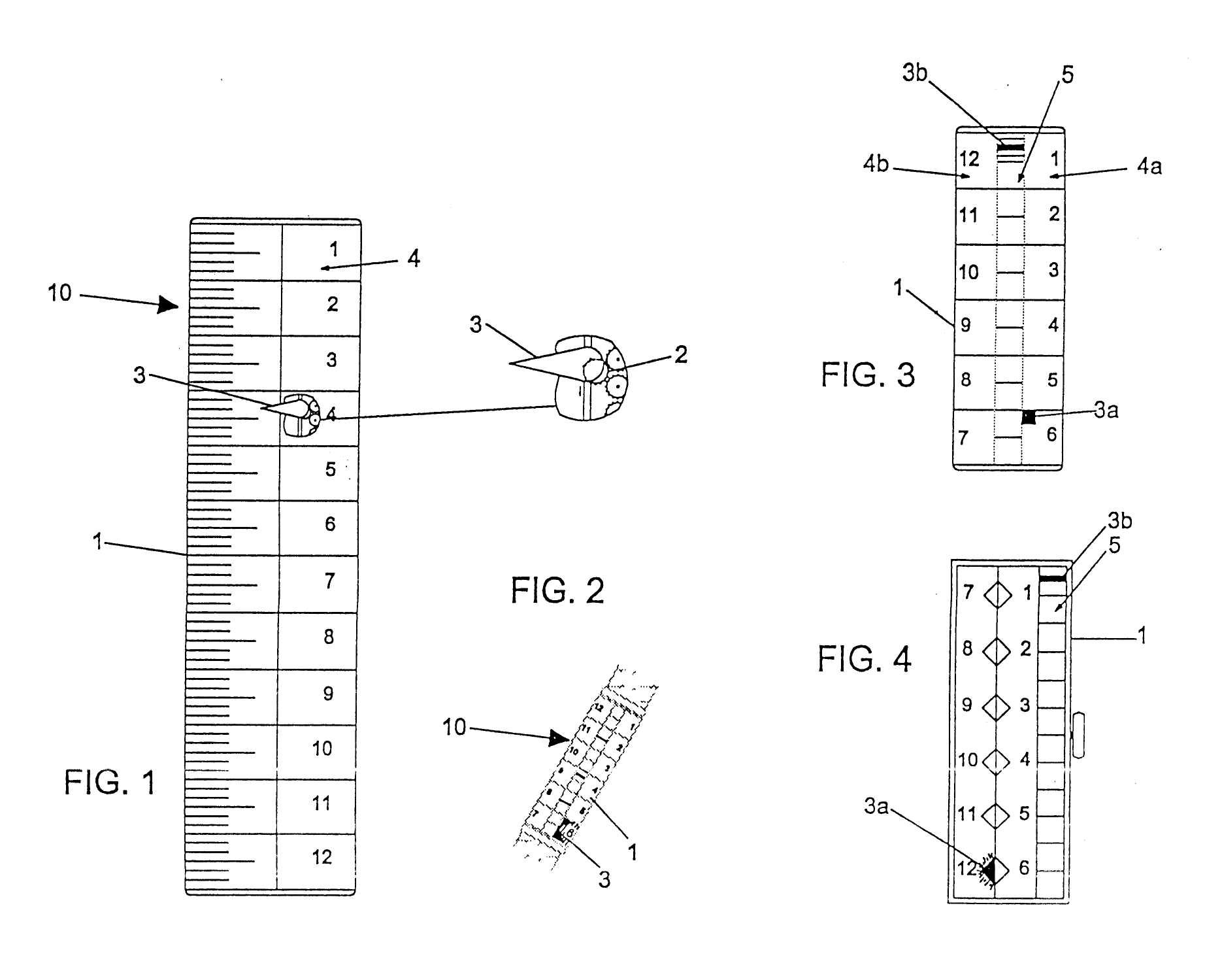

Since the cursor (2) performs a rectilinear movement, it has a constant linear speed determined depending on the size of the graduated scale (4). While still remaining within the scope of the protection guaranteed by the present application, various constructional solutions may be envisaged for the indicator (3) joined to the cursor (2), some of which have been shown in the accompanying figures: they may consist of a pointer, as shown in FIG. 1, which indicates a precise time, or a lens, as shown in FIG. 2, which magnifies the time shown, or also a luminous signal, which illuminates the time shown, as illustrated in FIGS. 3 and 4.

FIGS. 2, 3 and 4 also show a preferred constructional form, in which the clock or watch (10), forming the subject of the patent application, comprises at least one second graduated scale (5), so as to ensure separate scanning of the hours and the minutes.

Consequently, it comprises, within the casing (1), a pair of cursors (2a, 2b) which are respectively joined to a pair of indicators (3a, 3b) movable independently along two linear graduated scales (4, 5) so as to indicate separately hours and minutes. In particular, the indicator (3a) associated with the cursor (2a) for the graduated hour scale moves stepwise.

The invention thus conceived may be subject to numerous modifications and variations, all of which fall within the scope of the inventive idea.

Moreover, all the details may be replaced by technically equivalent elements.

In practice, modifications and/or improvements are possible, provided that they fall within the scope of the following claims.

What is claimed

1. Clock or watch, comprising a casing (1), at least one cursor (2) and an indicator (3) which are joined together and at least one first graduated scale (4), wherein the graduated scale (4) extends in a linear manner.

2. Clock or watch as claimed in claim 1, wherein the first graduated scale is divided into several sections (4a, 4b, etc.).

3. Clock or watch as claimed in claim 1, wherein the cursor (2) moves at a constant linear speed.

4. Clock or watch as claimed in claim 1, wherein the speed of the cursor (2) is determined depending on the size of the graduated scale (4).

5. Clock or watch as claimed in claim 3, wherein the speed of the cursor (2) is determined depending on the size of the graduated scale (4).

6. Clock or watch as claimed in claim 1, wherein the indicator (3) joined to the cursor (2) is a pointer able to indicate a precise time.

7. Clock or watch as claimed in claim 1, wherein the indicator (3) joined to the cursor (2) is a lens able to magnify the time shown.

8. Clock or watch as claimed in claim 1, wherein the indicator (3) joined to the cursor (2) is a luminous signal able to illuminate the time shown.

9. Clock or watch as claimed in claim 1, comprising at least one second graduated scale (5) so as to ensure separate scanning of the hours and the minutes.

10. Clock or watch as claimed in claim 1, comprising a pair of cursors (2a, 2b) respectively joined to a pair of indicators (3a, 3b) independently movable along two linear graduated scales (4, 5) so as to indicate separately hours and minutes.

11. Clock or watch as claimed in claim 10, wherein the indicator (3a) associated with the cursor (2a) for the graduated hour scale moves stepwise.

12. Clock or watch as claimed in the preceding claims and in accordance with that described and illustrated with reference to the figures of the accompanying drawings and for the objects mentioned.
